(19) United States
(12) Patent Application Publication
(10) Pub. No.: US 2007/0298713 A1
(43) Pub. Date: Dec. 27, 2007

(54) Method and system for location determination in cable TV networks

(76) Inventor: Carol Ansley, Alpharetta, GA (US)

Correspondence Address: ARRIS INTERNATIONAL, INC, 3871 LAKEFIELD DRIVE, SUWANEE, GA, 30024, US

(21) Appl. No.: 11/756,576

(22) Filed: May 31, 2007

Related U.S. Application Data
(60) Provisional application No. 60/809,729, filed on May 31, 2006.

(51) Int. Cl. H04B 7/00

(52) U.S. Cl. 455/41.2

(57) ABSTRACT

An RFID chip in an HFC tap contains a unique identifier. The identifier is sent to a user device coupled thereto in response to a request. The user device sends the identifier to a central device,such as a CMTS, along with a traffic stream, such as an emergency 911 call. A location determination storage system coupled to the CMTS receives the emergency call and the tap's unique identifier. The determination system includes a processor and a database that contains a list of tap identifiers and associated physical locations of corresponding taps. The database may be indexed on unique identifier so the physical location of the calling user device can be retrieved based on the unique identifier of the tap that accompanies the emergency message from the user device. Based on the retrieved location of the tap,emergency personnel can be dispatched to the location of the emergency call.

### CROSS REFERENCE TO RELATED APPLICATION

This application claims the benefit of priority under 35 U.S.C. 119(e) to the filing date of Ansley., U.S. provisional patent application No. 60/809,729 entitled “RFID used for location identification in CATV networks,” which was filed May 31, 2006, and is incorporated herein by reference in its entirety.

### FIELD OF THE INVENTION

This invention relates, generally, to communication networks and, more particularly, to determining the network location of an EMTA device.

### BACKGROUND

Currently, broadband networks may be used to provide traditional telephony service over community antenna television (“CATV”) or other communications networks using coaxial cable (“coax”) or optical fiber cable. For example, ARRIS Group, Inc. offers telephony over cable products known as VOICE PORT® and TOUCHSTONE® cable modems which interface a media terminal adaptor (“MTA”), or an embedded media terminal adaptor (“EMTA”), with a data network. These products are used by the CATV system operators to provide telephony services. Other companies also provide telephony services over broadband networks. An expectation of the end users of these telephony services is that the same level of services will be provided as if the customer was still using a traditional telephony land line. A significant issue that has arisen is provision for E911 access. Some providers that provide a strictly overlay service have difficulties becoming complaint with E911 requirements. E911 service requires that an operator be able to provide information to the emergency response provider as to the subscriber's exact location.

For the CATV operators, they are forced to rely upon the address given by the user when they contract the service. Because of the tree and branch architecture of the hybrid-fiber coax (HFC) network, the operator cannot provide an exact location for an EMTA within the network. There is concern that some users may take the EMTAs from one residence to another, with a resulting possibility of emergency responders going to the wrong location during an emergency.

Another existing technology that us being rapidly deployed within the business community is called RFID. This technology has two principal components, RF ID chips, and RF ID scanners. The technology has typically been deployed for product tracking. An RFID chip usually is placed onto an extremely low-cost paper or plastic container that also provides an external antenna for the chip. The RF ID scanners are usually handheld or fixed scanners that query the RFID chips for identification information. The RFID technology has been standardized for both the physical protocol and the logical protocols. There is a need in the art for a method and system to facilitate determining the physical location of an EMTA device in a cost-effective manner. The advances in the economics of scale of RFID devices have made that technology interesting for this purpose.

### BRIEF DESCRIPTION OF DRAWINGS

FIG. 1 illustrates a network diagram for performing location determination.

FIG. 2 illustrates a more detailed view of the EMTA and tap changes needed for location determination.

FIG. 3 illustrates a flow diagram of a method for performing location determination.

### DETAILED DESCRIPTION

As a preliminary matter, it will be readily understood by those persons skilled in the are that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

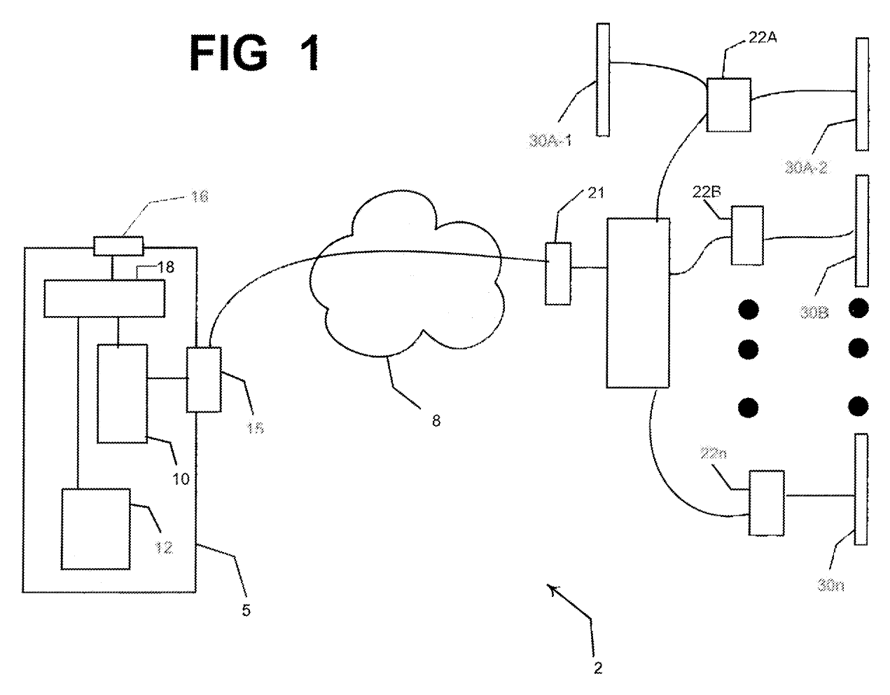

Turning now to the figures, FIG. 1 illustrates a network diagram showing a system 2 for determining the location of installed devices, for example EMTAs. Equipment at a service provider's central location head end 5, such as a cable modem termination system (“CMTS”) 10 couples to subscribers' user devices 30, such as an EMTA via a communication network 8, such as a hybrid fiber coaxial (“HFC”) network. Port 16 couples equipment at the head end 5 to a backbone network, such as the internet, via a protocol such as EMTA devices 30 typically couple to HFC 8 through taps 22. Typical HFC networks use fiber nodes 15 and 20 to connect traffic between the fiber and coaxial cable portions of the network. The coaxial portion(s) use amplifier(s) 21 to ensure adequate signal levels, and taps 22 perform the last level of signal distribution.

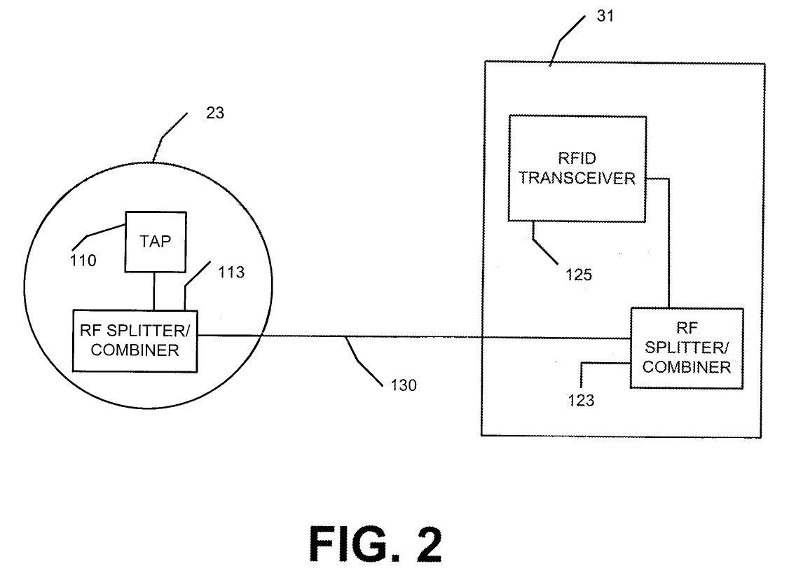

Turning now to FIG. 2, radio frequency identification device (“RFID”) technology is added to the tap 23 and EMTA 31, which correspond to taps 22A-n and EMTA 31A-n shown in FIG. 1. As known in the art, an RFID physical protocol can run over standard HFC components. Continuing with discussion of FIG. 2, upgraded tap 23 has an RFID chip 110 coupled to the RF splitter/combiner 113. Within the enhanced EMTA 31, an RFID scanner/transceiver 125 is connected to the tap. Thus,wireless RFID chip technology is used to drive RF signals through the weird coax connection 130. Equipment at the head end can cross reference information stored in location processor/database 12 shown in FIG. 1. System 12 is coupled to CMTS 10 through router 18, which also couples to backbone port 16.

Information in centrally located location determination storage system 12, which preferably includes a processor and a database that is accessible by the processor, includes a cross reference between a unique identifier of RFID chip 110 shown in FIG. 2, and the physical deployment location of the device in which it is embedded, attached, or otherwise associated. Thus, an operator of equipment at head end 5 as shown in FIG. 1, can determine the location from which traffic of a user device 31 originates.

For example, user device 31B in FIG. 1 (30B is replaced for purposes of discussion with 31B; the user device corresponds to, and is an example or, the first device recited in the claims) is normally served by tap 23B (corresponding to 22B in FIG. 1), but the first device may be moved to a different location and coupled to tap 23A, for example. Equipment at head end 5 can determine physically where traffic, a call traffic stream, for example, originates by comparing the RFID signal from the tap that is transmitted along with the message from the user device with the location of the tap associated with the RFID stored in the centrally located location determination storage system 12.

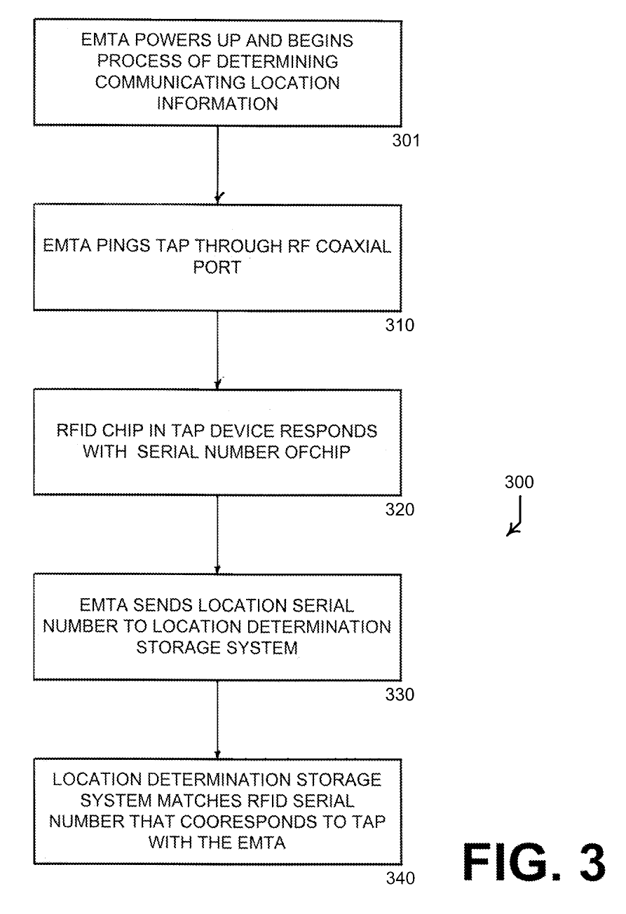

In the just-described embodiment, the location of the tap device 23 (the tap device corresponds to, and is an example of, the second device recited in the claims) is known because the tap locations are indexed according to RFID in the location database of system 12. Thus, emergency personnel and equipment can respond to the actual general vicinity of the user device 31, but may not know the exact house, or office, for example, because multiple user devices may be served by one tap device 23. In another embodiment, RFID chip 110 may be instead embedded, attached, or otherwise associated with a particular user device 31, rather that with a particular second device, as discussed in reference to previously described embodiment. In such a scenario, emergency personnel could use the RFID to cross reference the exact location of the user device from which an emergency call or other message is sent. It will be appreciated that in such a scenario, the database that cross references the RFID with the physical location may be updated when the particular user device performs ranging and registering according to the steps described below in reference to FIG. 3.

Turning now to FIG. 3, a flow diagram of a method 300 for performing location determination is shown. Method 300 starts at step 301. At step 301, EMTA either first initializes or receives a request from the network to conform its current location. It begins the process by initializing the RFID scanner. At step 310, the RFID scanner and responds with its unique identification code. At step 330, the RFID scanner receives and decodes the response from the RFID chip. That identification number is provided to the EMTA, which passes that information back up to the location tracking database. The RFID serial number of the RFID chip is sent to the location determination storage system located preferably at the head end, although it can be located elsewhere. In step 340, the location tracking database system associates the EMTA with its current reported location, by matching the tap's RFID serial number.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A system for determining the location of a first device that is coupled to a second device in a wired RF network, comprising:
first processor circuitry in the first device for performing an RFID scan;
second processor circuitry in the first device for formatting RFID identification numbers and sending them to a central network location;
RFID chip circuitry attached to the second device and coupled to the wired network; and
a centrally located location determination storage system coupled to the wired RF network at a central network location.

2. The system of claim 1 wherein the wired RF network is a cable TV hybrid fiber coax network.

3. The system of claim 1 wherein the first device is an EMTA or cable modem.

4. The system of claim 1 wherein the second device is a tap that interfaces one or more first devices with the wired RF network.

5. The system of claim 1 wherein the second device is a pass through device installed in the wired RF network above the first device.

6. A method for determining the location of a user device in a wired RF network, comprising:
transmitting a query signal into the wired RF network from the user device;
capturing the query signal at a signal at a second device coupled to the wired RF network; and
providing a unique identification signal from the second device over the wired RF network in response to the query signal.

7. The method of claim 6 further comprising receiving the unique identification signal response from the second device at the first device and sending an information message containing the received unique identification signal from the first device through the wired RF network to a centrally located location determination storage system.

8. The method of 7 wherein the begins upon a reset or power up condition of the first device

9. The method of 7 where the method begins upon a request from a hierarchically higher network element to verify the first device's current location.
